(19) United States
(12) Patent Application Publication
(10) Pub. No.: US 2024/0283111 A1
(43) Pub. Date: Aug. 22, 2024

(54) A CYLINDRICAL SECONDARY CELL WITH SHAPED CAN HOLE WALL AND A METHOD OF ITS ASSEMBLY

(71) Applicant: Northvolt AB, Stockholm (SE)

(72) Inventors: Brendan Sexton, Västerås (SE); Kenya Shatani, Stockholm (SE); Tetsuya Makino, Solna (SE)

(21) Appl. No.: 18/566,879

(22) PCT Filed: Jun. 3, 2022
(86) PCT No.: PCT/EP2022/065230

§ 371 Date: Dec. 4, 2023

(30) Foreign Application Priority Data
Jun. 4, 2021 (SE) 2150716-5

(51) Int. Cl. H01M 50/567; H01M 10/04; H01M 50/107; H01M 50/148; H01M 50/152; H01M 50/179; H01M 50/188; H01M 50/198; H01M 50/559; H01M 50/586; H01M 50/59

(52) U.S. Cl. CPC H01M 50/567; H01M 10/0422; H01M 50/107; H01M 50/152; H01M 50/154; H01M 50/179; H01M 50/188; H01M 50/198; H01M 50/559; H01M 50/586; H01M 50/59

(57) ABSTRACT

The present disclosure generally pertains to secondary batteries and components thereof. More specifically, the disclosure relates to According to a first aspect the present disclosure relates to a cylindrical secondary cell (1) comprising a cylindrical can (2) having a can end wall (2a), a terminal part (4) and an isolating part (7). The terminal part (4) comprises a pin shaped body inserted into a terminal through-hole (2b) formed in the can end wall (2a). The isolating part (7) is arranged in the terminal through-hole (2b) to electrically isolate the can end wall (2a) from the terminal part (4). An inner corner (2d) that is formed where an inner peripheral surface (2c) meets an inner surface (2f) of the can end wall (2a), is blunted and has a surface free from edges having edge angles of less than 100 degrees. The disclosure also relates to a method for attaching a terminal part to the shaped can end wall (2a) in a process of assembling the cylindrical secondary cell (1).

### TECHNICAL FIELD

The present disclosure generally pertains to secondary batteries and components thereof. More specifically, the disclosure relates to a cylindrical secondary cell with a shaped can hole wall and a method for attaching a terminal part to the shaped can end wall in a process of assembling the cylindrical secondary cell.

### BACKGROUND

In addressing climate change there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed. To achieve an effective production of rechargeable batteries, the design of the batteries as well as their manufacturing process can be optimized.

### SUMMARY

It is in view of the above considerations and others that the embodiments of the present invention have been made. The present disclosure aims at providing highly reliable secondary cells that are efficient in manufacture. In particular, it is an object to provide a secondary cylindrical cell having a terminal connection that is not damaged by forces applied in manufacturing and that is resistant to outer impact caused when using the cell.

According to a first aspect, the present disclosure relates to a cylindrical secondary cell comprising a cylindrical can having a can end wall, a terminal part and an isolating part. The terminal part comprises a pin shaped body inserted into a terminal through-hole formed in the can end wall and protruding out from the terminal through-hole into the cylindrical can to provide a connection to an electrode arranged inside the cylindrical can. The isolating part is arranged in the terminal through-hole to electrically isolate the can end wall from the terminal part. The isolating part covers an inner peripheral surface of the terminal through-hole and extends out from the terminal through-hole and over at least part of an inner surface of the can end wall. An inner corner that is formed where the inner peripheral surface meets an inner surface of the can end wall, is blunted and has a surface free from edges having edge angles of less than 100 degrees. The proposed cell is less vulnerable to forces applied in manufacturing as the inner corner of the terminal through-hole is blunted and has a surface free from edges having edge angles of less than 100 degrees. Hence, the risk that the isolating part is pierced or stressed by pressure of sharp edges in production is reduced. Lack of residual stress from production makes the isolating part more resistant to outer impact, such as temperature variations or shaking, caused when using the cell.

In addition, the risk that the isolating part is pierced or stressed by pressure of sharp edges while in use (for example due to shaking when a vehicle runs over a bump) is also reduced.

The blunted surface may also improve sealing properties of the isolating part due to that the number of times the electrolyte flow needs to change direction, for example to pass an edge, along a surface of the inner corner is increased.

In some embodiments, the inner corner is positioned within a virtual corner with regards to the can end wall, wherein the virtual corner is defined as the point where a virtual prolongation of the inner peripheral surface of the terminal through-hole intersects a virtual prolongation of the inner surface of the can end wall. In these embodiments, the blunted corner is achieved by removing the outer edge of the inner corner.

In some embodiments, the inner corner is formed such that the isolating part is prevented from folding more than 100 degrees at any point along the surface of the inner corner. Hence, folding of the insolating part, that could potentially cause stress or cracks in its surface is prevented.

In some embodiments, the inner corner is free from edges that pierce the isolating part while applying a rivet pressure force on the terminal part from inside the cylindrical can. Hence, short circuits and leakage caused by piercing is avoided.

The cylindrical secondary cell according to any one of the preceding claims, wherein the terminal through-hole is tapered from the inside the cylindrical can towards an outer opening. In some embodiments, the terminal through-hole is formed such that the isolating part is thicker at the inner corner than at an outer corner that is formed where the inner peripheral surface of the terminal through-hole meets an outer side of the can end wall. Thereby, flow of sealant may be improved or smoothened when sealing the can hole using injection molding. A smooth flow may prevent the residual stress in the isolating part and achieve good sealing properties.

In some embodiments, the isolating part extends out from the terminal through-hole over at least a part of an outer surface of the can end wall, and wherein an outer corner that formed where the inner peripheral surface meets and an outer surface of the can end wall, is blunted and has a surface free from edges having edge angles of less than 100 degrees. The blunted surface of the outer surface may improve sealing properties, due to that the number of edges that the electrolyte needs to pass on its way out is further increased. Furthermore, if both the inner and the outer corners are blunted the flow of the sealant may be further improved in injection molding.

In some embodiments, the isolating part is made of a deformable material that fills a remainder of the terminal through-hole not occupied by the terminal part. Hence, the isolating part is in direct contact with the can end wall. In some embodiments, the inner corner is chamfered. In other embodiments, the inner corner is rounded. In some embodiments, the inner corner has a corner radius of more than >=0.2 mm.

In some embodiments, the surface of the inner corner that is covered by the isolating part lacks edges sharper than 120 degrees or lacks edges sharper than 135 degrees. The more obtuse the edges are, the smaller is the risk for damage caused by the edges.

According to a first aspect of the present disclosure relates to a method for attaching a terminal part to a can end wall of a cylindrical can in a process of assembling a cylindrical secondary cell. The method comprises forming a terminal through-hole in a can end wall, wherein the terminal through-hole is formed such that an inner corner, that is formed where an inner peripheral surface of the terminal through-hole meets an inner surface of the can end wall, is blunted and has a surface free from edges having edge angles of less than 100 degrees. The method further comprises inserting a terminal part comprising a pin shaped body into the formed terminal through-hole to provide a connection to an electrode arranged inside the cylindrical can and arranging an isolating part on the inner peripheral surface of the terminal through-hole to electrically isolate the can end wall from the terminal part. The isolating part is arranged such that it covers the inner peripheral surface of the terminal through-hole and extends out from the terminal through-hole and over at least a part of the inner surface of the can end wall. As described above, the risk of damage of the isolating part is reduce as the inner corner of the terminal through-hole is blunted and has a surface free from edges having edge angles of less than 100 degrees. Hence, the risk that the isolating part is pierced or stressed by pressure of sharp edges is reduced.

In some embodiments the method comprises, applying a rivet pressure force on the terminal part from inside and outside the cylindrical can, to rivet the terminal part to the can end wall. The blunted surface reduces the risk of damaging the isolating part when applying the force. Hence, the execution of this step may become simpler.

In some embodiments the method comprises arranging an isolating part formed such that a portion of the isolating part that surrounds a shaft portion of the terminal part that is inserted in the terminal through hole, is thicker at its middle, and/or at its inner end, than at its outer end, with regards to the cell. In this way it can be assured that an empty space freed by the blunting of the inner corner is properly sealed.

In some embodiments the arranging comprises insert injection molding the isolating part by filling a remainder of the terminal through-hole not occupied by the terminal part by an isolating material, wherein the molding fixates the terminal part in the terminal through-hole. Insert injection molding is a proven technology, that requires less components than riveting.

In some embodiments the method comprises assembling a cylindrical secondary cell according to any embodiment of the first aspect.

### BRIEF DESCRIPTION OF THE DRAWINGS

The embodiments disclosed herein are illustrated by way of example, and by not by way of limitation, in the figures of the accompanying drawings. Like reference numerals refer to corresponding parts throughout the drawings, in which

FIG. 1 illustrates, in cross-section, one end of a cylindrical secondary cell according to the first aspect.

FIG. 2 illustrates a terminal part of the cylindrical secondary cell of FIG. 1 in more detail.

FIGS. 3A and 3B illustrate alternative shapes of a can hole.

FIG. 4 illustrates resin damage during riveting.

FIG. 5 is a flow chart if the method for attaching a terminal part to a can end wall of a cylindrical can in a process of manufacturing a cylindrical secondary cell, according to the second aspect.

FIGS. 6A to 6D illustrate attaching a terminal part of a cylindrical secondary cell using riveting.

FIGS. 7A to 7D illustrate attaching a terminal part of a cylindrical secondary cell using molding.

### DETAILED DESCRIPTION

A rechargeable battery, often referred to as a secondary battery, typically comprises one or more secondary cells (herein referred to as simply a cells) electrically connected to each other. A cell having both terminals arranged at one end may bring advantages with regards to electrically connecting the cell to a load. Conductors electrically connecting the terminals to the load may then be positioned on the same end, the terminal end, of the cell. The opposite end, the electrolyte-filling end, of the cell may be dedicated to electrolyte filling and gas venting. An overpressure may be generated within the cell during operation, in particular upon malfunction of the cell or of the load connected to the cell. Such malfunction may require a release of gas and/or electrolyte out of the cell, and it may be advantageous to direct the released gas and/or electrolyte away from the conductors.

Furthermore, a plurality of cells is typically positioned at a low position in an electric vehicle. The cells may be arranged with their terminal ends directed upwards and the electrolyte-filling ends directed downwards. Upon malfunction, for example resulting from a faulty electric vehicle charger or a faulty cell, a release of gas and/or electrolyte from the electrolyte-filling end(s) will be advantageously directed downwards towards the ground beneath the vehicle. When both terminals of a cell are arranged at one end of the cell, isolation between the conductors that are electrically connecting the terminals to the load is very important. Typically, one terminal is formed by the enclosure of the cell, also referred to as the can. The conductor of the other terminal typically extends through a can hole in the can end wall. In order to achieve isolation between the conductor and the can, an isolating part is arranged between the conductor and the can end wall. The isolation also serves as a seal preventing the electrolyte from leaking out from the can. However, the isolating part may be exposed to stress both during use and manufacturing, which may affect the sealing properties and cause short circuits.

This disclosure relates to a secondary cylindrical cell having both terminals arranged at one end. The cell comprises an isolating part (sometimes referred to as simply a resin) arranged in a can hole at the end comprising the terminals to isolate a terminal part from the can end. The proposed technique is based on the insight that improved sealing and reduced risk for damage may be achieved if the surface of the can end on which an isolating part is pressed is shaped in certain ways, in particular if it is free from sharp edges. More specifically a cylindrical secondary cell is proposed having a can hole shape that contributes to achieving improved sealing properties and reduces the risk for damage of the isolating part during manufacturing and subsequent use of the cell.

Embodiments of the present disclosure will now be described more fully hereinafter, with reference to the figures. The same reference numbers are used throughout the figures. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

FIG. 1 illustrates a cylindrical secondary cell 1 (hereinafter also referred to as cell 1) comprising a cylindrical can 2 having a can end wall 2a (the top end wall of the cylindrical can in FIG. 1) and an opposite can end (not shown). In this application the terms ‘inner’ and ‘outer’ are used with reference to the center of the cell 1. The cylindrical can 2 may also be referred to as an enclosure. The can end wall 2a may be formed in one piece with the cylindrical can 2 (as illustrated in FIG. 1) and the other can end may be formed by a separate can end lid (not shown), or vice versa. Both the can ends may alternatively be formed by respective lids.

The cylindrical can 2 is filled with an electrolyte. An electrode assembly 3, typically a jelly-roll, is arranged inside the cylindrical can 2. A jelly-roll is a commonly used type of electrode assembly having a structure in which a positive electrode and a negative electrode each having a long sheet shape are wound with a separator interposed in-between. The cell 1 further comprises an electrode lead plate 6 that is arranged at one end of the electrode assembly 3. The electrode lead plate 6 is in direct electrical contact and physical with one of the electrodes of the electrode assembly, typically the positive electrode. The electrode lead plate 6 may be attached, for example welded, for example laser welded, to the positive electrode. The present disclosure relates to the end comprising the conductors electrically connecting the terminals and therefore the electrode assembly and the electrolyte filling end is not described in detail.

The cell 1 has, as discussed above, both a positive terminal and a negative terminal at one and the same end (the top end in FIG. 1) of the cell 1. The can end wall 2a comprises a central terminal through-hole 2b (also referred to as can hole) for a terminal part 4 forming the positive terminal. The negative terminal is electrically connected to the cylindrical can 2 (not shown).

More precisely, the negative terminal is formed by the outer surface 2g of the can end wall 2a that surrounds the terminal through-hole 2b. Thus, the entire cylindrical can 2 (apart from the terminal part 4 at the top end) may be the negative terminal.

The terminal part 4 provides a connection to an electrode of the electrode assembly 3 arranged inside the cylindrical can 2. The terminal part 4 is inserted into the terminal through-hole 2b formed in the can end wall 2a. The terminal part 4 protrudes out from the terminal through-hole 2b, and through the inner opening, into the cylindrical can 2. The terminal part 4 extends through the can end wall 2a and has an outer, or first, end 4a and an inner, or second, end 4b. The outer end 4a of the terminal part 4 may form the positive terminal of the cell 1. In the embodiments of the present disclosure, the terminal part 4 is rotational symmetric around its longitudinal center axis (not illustrated).

The terminal part 4 is in direct electrical contact with an electrode lead plate 6. More specifically, the terminal part 4 is in direct electrical and physical contact with the electrode lead plate 6. More precisely, the inner end 4b of the terminal part 4 is in direct electrical contact with the electrode lead plate 6. The inner end 4b may be attached, for example welded, for example laser welded, to the electrode lead plate 6. An isolating part 7 is arranged in the terminal through-hole 2b to electrically isolate the can end wall 2a from the terminal part 4. The isolating part 7 also serves as a seal preventing the electrolyte from leaking out from the cylindrical can 2.

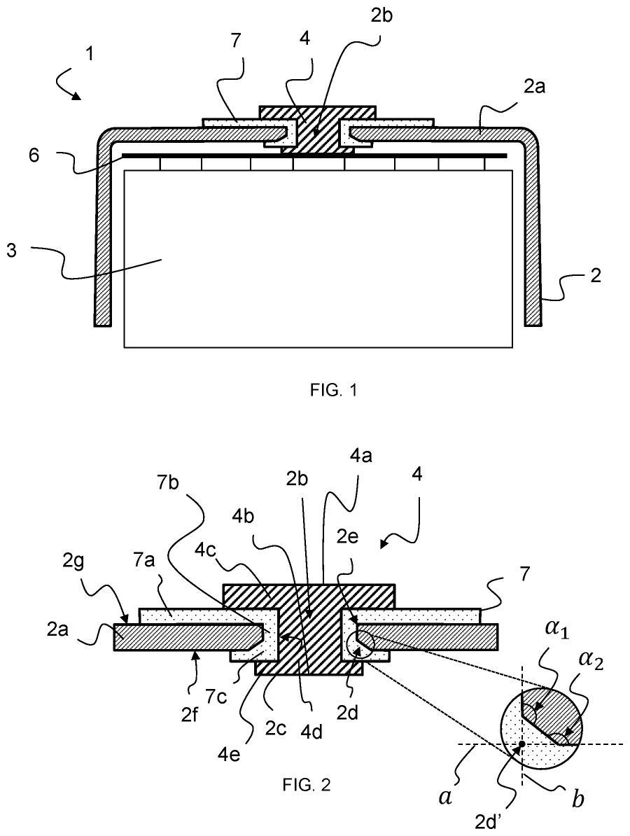

FIG. 2 illustrates the terminal through-hole 2b, the terminal part 4, and the isolating part 7 of the cell 1 in more detail. The terminal through-hole 2b is defined by an inner peripheral surface 2c of the can end wall 2a. In some embodiments a center line of the terminal through hole is perpendicular to a center line of the can end wall 2a. The terminal through-hole 2b has an inner opening and an outer opening (in relation to the cell 1). An inner corner 2d, is formed where the inner peripheral surface 2c meets an inner surface 2f of the can end wall 2a. In the embodiment of FIG. 2, the inner peripheral surface 2c and the inner surface 2f are perpendicular. An outer corner 2e, is formed where the inner peripheral surface 2c meets an outer surface 2g of the can end wall 2a. In the embodiment of FIG. 2, the inner peripheral surface 2c and the outer surface 2g are perpendicular. A corner herein typically refers to an area where two sides meet. A corner may be formed by one or several edges. If the corner consists of one single edge, then the edge is the corner. However, if the corner comprises two edges (a chamfered corner) then the corner is an area covering at least the two edges and the surface between the two edges. The corner may also be rounded. The corner is then defined as an area corresponding to the rounded surface forming the intersection between the inner peripheral surface 2c and the outer surface 2g are perpendicular.

The surface of the inner corner 2d is blunted, which means that is has an obtuse or dull edge. A blunted surface is a surface free from sharp angularities, projections or corners. In this context angles of less than 100 degrees are considered sharp, in the sense that they for example risk causing damage to the isolation part 7. More specifically, the inner corner is free from edges of less than 100 degrees. In other words, the inner corner 2d is typically not one single edge but a place or area where the inner peripheral surface 2c meets the inner surface 2f of the can end wall 2a.

The blunted corner is typically achieved by removing (for example by grinding or cutting off) the outer part of the inner corner 2d after forming the through-hole 2b. This is for example done by grinding, rasping or similar. In other words, the inner corner is retracted from its virtual position (where it would have been positioned if not blunted). In other words, the inner corner 2d is positioned within a virtual corner 2d′ with regards to the can end wall 2a, wherein the virtual corner 2d′ is defined as the point where a virtual prolongation a of the inner peripheral surface 2c of the terminal through-hole 2b intersects a virtual prolongation b of the inner surface 2f of the can end wall 2a. A prolongation of a surface herein corresponds to a virtual extension of the surface. This is illustrated by the enlarged image of the inner corner in the lower right corner of FIG. 2. In some embodiments, a distance between the inner corner 2d and the virtual corner 2d′ is at least 0.08 mm, at least 0.12 mm or at least 0.2 mm.

In the illustrated embodiment the inner corner 2d is chamfered. More specifically, in the illustrated embodiment the surface of the inner corner 2d comprises two edges both having edge angles α₁, α₂ of about 135 degrees. In alternative embodiments, the blunting of the inner corner 2d is achieved in other ways. For example, the inner corner 2d may have a polygonal surface. In other words, the inner corner may have a surface with a plurality of (very) obtuse edges. Hence, in some embodiments, the surface of the inner corner 2d that is covered by the isolating part 7 lacks edges sharper than (that is smaller than or below) 120 degrees or even lacks edges sharper than 135 degrees.

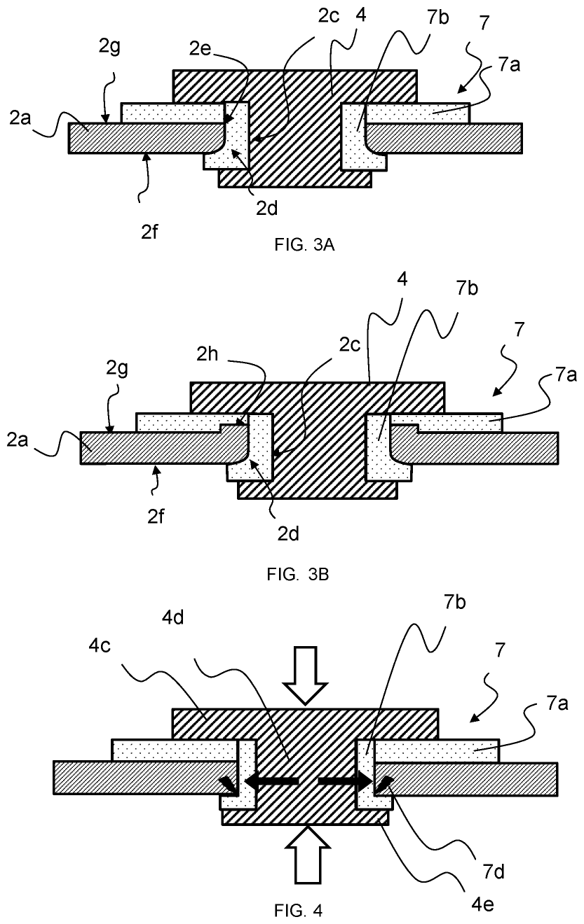

In some example embodiments, the inner corner 2d is rounded, as illustrated in FIGS. 3A and 3B. FIG. 3A illustrates a terminal through-hole 2b where the inner corner 2d is rounded by means of radiusing, or corner rounding. In this example the isolating part 7 comprises a first portion 7a and a second portion 7b that together forms the isolating part 7.

FIG. 3B illustrates a terminal through-hole 2b where the inner corner 2d is formed by burring processing. Burring processing is performed by first forming a punched hole in the can end wall 2b and then forming a vertical wall 2h by expanding the punched hole by force from inside the cell 1.

Radiusing or burring of the inner corner 2d can be used to form rounded corners having different radii. For example, the inner corner 2d has a corner radius of more than 0.2 mm, more than 0.3 mm, more than 0.5 mm, or more than 0.7 mm. In both these examples, the isolating part 7 comprises a first portion 7a and a second portion 7b formed in separate pieces that together constitute the isolating part 7.

Now turning back to FIG. 2. The terminal part 4 comprises a pin shaped body with a head portion 4c and a shaft portion 4d. During manufacture of the cell 1, the pin shaped terminal part 4 may be riveted, thus plastically deformed, such that a portion of the shaft portion 4d is expanded radially. The head portion 4c of the terminal part 4 may also be called factory rivet head.

The shaft portion 4d is deformed to form a so-called shop rivet head 4e. The shop rivet head 4e hinders the terminal part 4 (that may be referred to as a terminal rivet) from being pulled out of the terminal through-hole 2b in the can end wall 2a. In the illustrated embodiment of FIGS. 1 and 2, the terminal part 4 has the shape of a pin shaped rivet with a shop rivet part 4e.

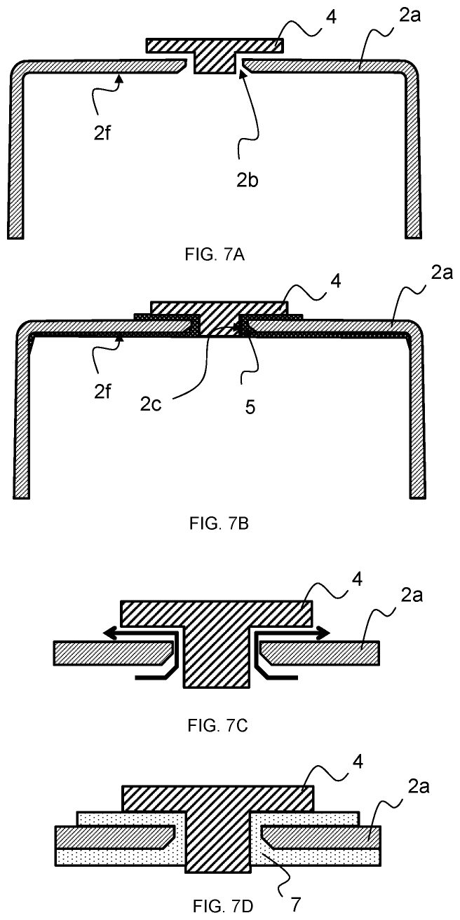

In alternative embodiments, the terminal part 4 may be attached in other ways. For example, the terminal part 4 is attached by molding as described in connection with FIGS. 7A to 7D.

The electrically isolating part 7, which may also be referred to as a rivet gasket, is configured to surround the terminal part 4. The isolating part 7 may be assembled by one or several parts including but not limited to tubular shapes (circular cylindrical shells) and discs (also called O-rings). In some embodiments, the isolating part 7 comprises resin, such as Polypropylene (PP), Polybutylene terephthalate (PBT), Perfluoroalkoxy alkane (PFA), Polytetrafluoroethylene (PTFE), Polyphenylene Sulfide (PPS), Polyether ether ketone (PEEK) or the like or a combination thereof. In some embodiments, the isolating part 7 alternatively, or in addition, made from rubber, such as Styrene-butadiene rubber (SBR), Ethylene propylene diene monomer rubber (EPDM), Silicone Elastomer, Fluorocarbon rubber (FKM) or the like or a combination thereof. As is illustrated, the isolating part 7 surrounds the entire shaft portion 4d. The isolating part 7 may comprise or consist of one or more portion, that are separate (and joined while assembling the cell) or formed in one part. More in detail, the isolating part 7 may comprise or consist of a first portion 7a that is arranged between the head portion 4c, and the can end wall 2a and a second portion 7b that surrounds the shaft portion 4d. In the embodiment illustrated in FIGS. 1 and 2, the isolating part 7 means is rotational symmetric. The first portion 7a may be an annular disc, with an outer diameter that is larger than the head portion 4c. To ensure electrical isolation the first portion 7a typically extends outside the head portion 4c of the terminal part 4. In other words, the diameter of the first portion 7a is larger that the diameter of the head portion 4c. The inner diameter of the first portion 7a may correspond to the diameter of the shaft portion 4d. Thus, the first portion 7a may electrically isolate the head portion 4c, more precisely the inner (i.e. towards the cell 1) surface of the head portion 4c, from the can end wall 2a.

The shaft portion 4d extends through a through-going-hole (the terminal through-hole 2b) in the can end wall 2a and is electrically isolated from the through-hole by the second portion 7b of the electrically isolating part 7. In the embodiment of FIGS. 1 and 2 the second portion 7b is tubular (i.e. a circular cylindrical shell).

The electrically isolating part 7 also comprises a third portion 7c that is arranged between the shop rivet head 4e and the can end wall 2a. To ensure electrical isolation the third portion 7c typically extends outside the shop rivet head 4e of the terminal part 4. In addition, the third portion 7c may extend inside the can end wall 2a and along the inner surface 2f of the can end wall 2a to electrically isolate the electrode lead plate 6 from the can end wall 2a. In some embodiments the third portion covers the entire electrode lead plate 6. The third portion 7c may be an annular disc, with an outer diameter that corresponds to the outer diameter of the electrode lead plate 6 and an inner diameter that corresponds to the diameter of the shaft portion 4d. In some embodiments, the third portion 7a extends over the entire inner surface 2f of the can end wall 2a. Typically the electrode lead plate 6 is also surrounded by isolation. If the third portion 7c covers the entire electrode lead plate 6 may be joined with the isolating part surrounding the electrode lead plate 6. In other words, the isolating part 7 covers the inner peripheral surface 2c of the terminal through-hole 2b and extends out from the terminal through-hole 2b and over at least part of the (or the entire) inner surface 2f of the can end wall 2a. Hence, the isolating part 7 extends over an inner corner 2d, that is formed where the inner peripheral surface 2c meets the inner surface 2f of the can end wall 2a.

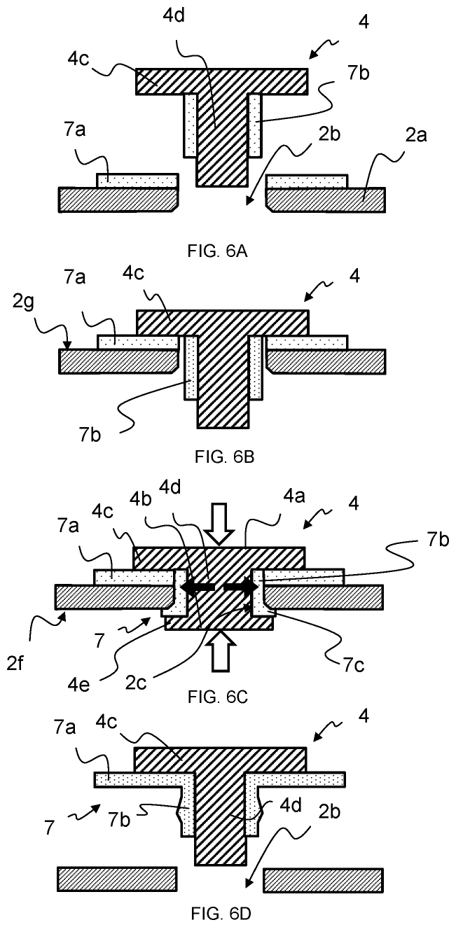

If the terminal part 4 is manufactured using riveting a rivet pressure force on the terminal part 4 from inside the cylindrical can 2. The isolating part 7 is then pressed against the can end wall 2a. Edges on the inner corner 2d may then cause stress on the isolating part, which may reduce the isolating properties of the isolating part 7. The sharper edges the higher is the risk that the isolating part 7 will be damaged or even pierced by the edges, which may lead to a short-circuit between the electrodes. FIG. 4 illustrates how straight edges of 90 degrees in a surface of the inner corner 2d may cause cracks 7d in an isolating part 7 in a riveting process (See FIGS. 6A to 6D). However, as the inner corner 2d is blunted and free from sharp edges narrower than 100 degrees, the risk that the inner corner 2d will damage the isolating part 7 is reduced. In other words, the inner corner 2d is free from edges that pierce the isolating part 7 while applying a rivet pressure force on the terminal part 4 from inside the cylindrical can 2.

In some embodiments, the isolating part 7 is made of a moldable or deformable material. During manufacturing the isolating part 7 is typically molded (by pressure or molding) such that it fills a remainder of the terminal through-hole 2b not occupied by the terminal part 4. The isolating part 7 is arranged directly on the inner corner 2d. Thus, in the manufacturing process the isolating part 7 will typically obtain a shape corresponding to the shape of the corner 2d. In other words, in some embodiments, the inner corner 2d is formed such that the isolating part 7 is prevented from folding more than 100 degrees at any point along the surface of the inner corner 2d.

In the illustrated embodiments the outer corner 2e is sharp. However, it may be desirable to blunt this corner too. Hence, in some embodiments the isolating part 7 extends out from the terminal through-hole 2b over at least a part of the outer surface 2g of the can end wall 2a, and wherein an outer corner 2e that formed where the inner peripheral surface 2c meets and the outer surface 2g of the can end wall 2a, is blunted and has a surface free from edges having edge angles of less than 100 degrees.

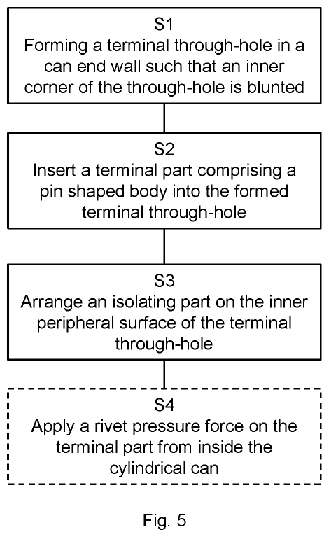

For better understanding of the proposed technique and associated effects methods for attaching a terminal part to a cylindrical secondary cell will now be described with reference to FIGS. 5, 6A-6D and 7A-D. FIG. 5 is a flow chart of the method for attaching a terminal part to a can end wall of a cylindrical can in a process of manufacturing a cylindrical secondary cell. In the method, some steps are optional or associated with a particular embodiment. These steps are illustrated by dashed borders. FIGS. 6A to 6D illustrate attaching the terminal part 4 using riveting and FIG. 7A to 7D illustrate attaching a terminal part of a cylindrical secondary cell using molding.

Before the terminal part 4 can be attached, independent of which fastening technique is used, a terminal through-hole 2b has to be formed in the can end wall 2a. For example, the terminal through-hole 2b is drilled, cut out or punched in the center of a can end wall 2a having a circular shape. Alternatively, the terminal through-hole 2b is formed while molding the can end wall 2a. In other words, the method comprises forming S1 a terminal through-hole 2b in a can end wall 2a. The inner corner 2d, that is formed where an inner peripheral surface 2c of the terminal through-hole 2b meets an inner surface 2f of the can end wall 2a, is blunted, as described above in connection to FIGS. 1 to 3. The blunting may be performed at the same time as forming the hole, or afterwards by grinding or similar. The blunting is performed such that a surface free of the inner corner 2d is free from edges having edge angles of less than 100 degrees, as described in connection with FIGS. 1 and 2. The inner corner may be formed in any way described in connection with FIGS. 1 and 2.

The terminal part 4 may then be fixated in the formed terminal through-hole 2b using for example riveting or molding. Attaching the terminal part using riveting will first be described with reference to FIGS. 5 and 6A to 6C. FIG. 6A illustrates the terminal part 4, the can end side 2b comprising a terminal through-hole 2b and the isolating part 7, before inserting the terminal part 4 in the terminal through-hole 2b. In the embodiment illustrated in FIG. 6A, the isolating part 7 comprises a first portion 7a and a second portion 76. The terminal part 4 comprises a pin shaped body with a head portion 4c and a shaft portion 4d. The first portion 7a is an annular disc which is arranged on the outer surface 2g of the can end wall 2a around the outer opening of the terminal through-hole 2b. The second portion 7b is a tube arranged around the shaft portion 4d of the terminal part 4.

The terminal part 4 is then inserted in the terminal through-hole 2b from the outer side (facing out from the cell 1) of the can end wall 2a, as shown in FIG. 6B. The inner (i.e. towards the cell 1) surface of the head portion 4c is then brought into contact with the first portion 7a of the isolating part. The second portion 7b is now positioned in the terminal through-hole 2b, but is not in contact with the inner peripheral surface 2c of the terminal through-hole 2b. Also, note that at this stage the first portion 7a and a second portion 7b of the isolating part 7 are still separated from each other. In other words, the method comprises inserting S2 a terminal part 4 comprising a pin shaped body into the formed terminal through-hole 2b and arranging S3 an isolating part 7 on the inner peripheral surface 2c of the terminal through-hole 2b to electrically isolate the can end wall 2a from the terminal part 4. In this example embodiment, the inserting S2 and the arranging S3 is partly performed at the same time. Hence, the isolating part 7 is arranged in the terminal through-hole 2b by arranging the first portion on the outer surface 2g of the can end wall 2a and inserting the second portion 7b in the terminal through-hole 2b, such that the second portion 7b covers the inner peripheral surface 2c of the terminal through-hole 2b. The terminal part 4 will eventually provide a connection to an electrode arranged inside the cylindrical can 2 of the assembled cell 1.

To complete the riveting a riveting force is applied to the outer end 4a and inner end 4b of the terminal part 4 as illustrated by the arrows in FIG. 6C. In other words, the method comprises applying a rivet pressure force on the terminal part 4 from inside and outside the cylindrical can 2 to rivet the terminal part 4 to the can end wall 2a. The shaft portion 4d of terminal part 4 is swelling in riveting process. Hence, after the riveting the second portion 7b of the isolating part 7 will be in contact with the inner peripheral surface 2c of the terminal through-hole 2b. Also the first and second portions 7a, 7b of the isolating part 7 will be joined to form one seal. The shaft portion 4d is also deformed by the riveting to form a so-called shop rivet head 4e, as explained in connection with FIG. 2. In the same way the second portion 7b of the isolating part 7 is deformed (bent out) such that it now extends out from the terminal through-hole 2b and over at least a part of the inner surface 2f of the can end wall 2a. The bent-out portion forms a third portion 7c of the isolating part 7.

In the illustrated embodiment the inner corner 2d is chamfered. The chamfered hole can prevent the isolating part 7 from breaking, as the edges that the isolating part 7 are pressed against in the riveting are obtuse as discussed above. The chamfered hole may also contribute to good sealing and insulating properties, as the number of times that the electrolyte flow needs to change direction for to leave the cylindrical can 2 is increased. In other words, the number of edges the electrolyte needs to pass on its way out is increased. A similar effect may be achieved by a rounded inner corner 2d, as a rounded corner from a sealing perspective corresponds to a very large (or even infinite) number of direction changes or “turns”.

FIG. 6D illustrates an alternative shape of the isolating part 7. In this example the isolating part 7 is formed in one piece. More specifically, the first portion 7a and the second portion are formed in one piece which is arranged around the terminal part 4 before inserting it in the through-hole. In the example embodiment, the second portion 7b of the isolating part 7, that surrounds the shaft portion 4d of the terminal part 4, is thicker in the middle with regards to the direction of the shaft. Thicker herein refers to the thickness of the isolating material. For example, a tubular gasket that has a shell or wall that is thicker at the middle is used. In other words, the second portion 7a is tapered towards its outer end and towards its inner end (with reference to the cell 1). More specifically, it is tapered towards the end facing the head portion 4c of the terminal part 4 and towards its end facing into the cell 1. The tapering towards the inner end, will facilitate the insertion in the terminal through-hole 2b. As an alternative (not shown) second portion 7b the isolating part 7 is only tapered towards its outer end. In other words, it is thicker at the inner end with regards to the cell 1.

By arranging S3 an isolating part that has a shaft portion 4d that is thicker at the middle (or alternatively at its inner end) it is assured that the seal will fill the empty space caused by the blunting (for example removal or tapering) of the inner corner 2d.

The illustrated embodiments of the isolation part 7 may be combined in different ways. For example, the isolating 7 part may be formed by two or more separate portions (as in FIG. 6A-6C) and the second portion 7b that surrounds the shaft portion of the terminal part 4 may be thicker at the middle or inner end as in FIG. 6D. Alternatively, the isolating part 7 may be formed in one piece (as in FIG. 6D) with a straight (evenly thick) second portion 7b, that has the same thickness along the whole second portion 7b (as in FIGS. 6A-C). In other words, in some embodiments the arranging S3 comprises arranging an isolating part 7 formed such that a portion of the isolating part 7 that surrounds a shaft portion 4d of the terminal part 4 which is inserted in the terminal through hole 2b, is thicker at its middle, and/or at its inner end, than at its outer end, with regards to the cell 1.

The rest of the riveting may then be performed in the same way as described in connection with FIGS. 6A to 6C.

Attaching the terminal part using insert injection molding will now be described with reference to FIGS. 5 and 7A to 7D. Insert injection molding is the process of molding or forming a mold (a plastic part) around other, typically non-plastic parts, or inserts. The inserted components are here the terminal part 4 and the can end wall 2a. Insert injection molding is a proven assembly technology and requires less components than the riveting.

In the same way as when using riveting the terminal part 4 is inserted in the terminal through-hole 2b from the outer side (facing out from the cell 1) of the can end wall 2a, as shown in FIG. 7A. In other words, the method comprises inserting S2 a terminal part 4 comprising a pin shaped body into the formed terminal through-hole 2b to provide a connection to an electrode arranged inside the cylindrical can 2. When using insert injection molding mechanical positioning and fixing of the terminal part 4 to the can end wall 2a is also required. This is done by a mold or suspension.

A sealant 5 (typically hot), such as a thermo plastic resin, is then injected between the terminal part 4 and the can end wall 2a and on the inner surface 2f of the can end wall, whereby the isolating part 7 is formed, see FIG. 7B. Thermoplastic resins are materials that soften to a liquid in high heat, and then harden again when cooled. In other words, the method comprises arranging S3 an isolating part 7 on the inner peripheral surface of the terminal through-hole 2b to electrically isolate the can end wall 2a from the terminal part 4. More specifically, the arranging S3 is performed by filling a remainder of the terminal through-hole 2b not occupied by the terminal part 4 by an isolating material, wherein the molding fixates the terminal part 4 in the terminal through-hole 2b.

In the illustrated embodiment the isolating part 7 formed by the insert injection molding covers the entire inner surface 2f of the can end wall 2a. The isolation part 7 will then also isolate the can end wall 2b from the electrode lead plate 6 (see FIG. 1). In other words, the isolating part 7 is arranged such that it covers the inner peripheral surface 2c of the terminal through-hole 2b and extends out from the terminal through-hole 2b and over at least a part of the inner surface 2f of the can end wall 2a.

In the illustrated example the through-hole 2b is wider at the inner opening than at the outer opening. This may be advantageous as it may improve the flow when inserting the sealant, as illustrated by the arrows in FIG. 7C. Generally, residual stress can be caused by non-uniformity of mechanical features of the sealed objects like difference in linear expansion coefficients. Residual stress may affect sealing properties. The residual stress may also be caused by non-uniformities in the cooling process and also by the flow of the sealant in the injection process. Hence, if the flow of the sealant is smoothened residual stress may be mitigated.

The resulting seal is illustrated in FIG. 7C. The sealant has now formed an isolating part 7 that is thicker at the inner opening than at the outer opening of the terminal through-hole 7, as illustrated in FIG. 7C. In other words, in some embodiments, the terminal through-hole 2b is formed such that the isolating part 7 is thicker at the inner corner 2d than at the outer corner 2e that is formed where the inner peripheral surface 2c of the terminal through-hole 2b meets the outer surface 2g of the can end wall 2a. Stated differently, the terminal through-hole 2b is tapered from the inside the cylindrical can 2 towards an outer opening.

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure.

For example, the cylindrical secondary cell is shown as being circular cylindrical. However, other cross-sections, such as a rounded square or a rounded rectangular cross-section, are also conceivable. Furthermore, the anode and the cathode may switch place.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1. A cylindrical secondary cell (1) comprising:
a cylindrical can (2) having a can end wall (2a),
a terminal part (4) comprising a pin shaped body inserted into a terminal through-hole (2b) formed in the can end wall (2a) and protruding out from the terminal through-hole (2b) into the cylindrical can (2) to provide a connection to an electrode (3) arranged inside the cylindrical can (2), and
an isolating part (7) arranged in the terminal through-hole (2b) to electrically isolate the can end wall (2a) from the terminal part (4),
wherein:
the isolating part (7) covers an inner peripheral surface (2c) of the terminal through-hole (2b) and extends out from the terminal through-hole (2b) and over at least part of an inner surface (2f) of the can end wall (2a), and
an inner corner (2d) of the can end wall (2a), that is formed where the inner peripheral surface (2c) of the terminal through-hole (2b) meets an inner surface (2f) of the can end wall (2a), is blunted and has a surface free from edges having edge angles of less than 100 degrees.

2. The cylindrical secondary cell (1) according to claim 1, wherein the inner corner (2d) is positioned within a virtual corner with regards to the can end wall (2a), wherein the virtual corner is defined as the point where a virtual prolongation of the inner peripheral surface (2c) of the terminal through-hole (2b) intersects a virtual prolongation of the inner surface (2f) of the can end wall (2a).

3. The cylindrical secondary cell (1) according to claim 1, wherein the inner corner (2d) is formed such that the isolating part (7) is prevented from folding more than 100 degrees at any point along the surface of the inner corner (2d).

4. The cylindrical secondary cell (1) according to claim 1, wherein the inner corner (2d) is free from edges that pierce the isolating part (7) while applying a rivet pressure force on the terminal part (4) from inside the cylindrical can (2).

5. The cylindrical secondary cell (1) according to claim 1, wherein the terminal through-hole (2b) is tapered from the inside the cylindrical can (2) towards an outer opening.

6. The cylindrical secondary cell (1) according to claim 1, wherein the isolating part (7) is made of a deformable material that fills a remainder of the terminal through-hole (2b) not occupied by the terminal part (4).

7. The cylindrical secondary cell (1) according to claim 1, wherein the terminal through-hole (2b) is formed such that the isolating part (7) is thicker at the inner corner (2d) than at an outer corner (2e) that is formed where the inner peripheral surface (2c) of the terminal through-hole (2b) meets an outer surface (2g) of the can end wall (2b).

8. The cylindrical secondary cell (1) according to claim 1, wherein the inner corner (2d) is chamfered.

9. The cylindrical secondary cell (1) according to claim 1, wherein the inner corner (2d) is rounded.

10. The cylindrical secondary cell (1) according claim 9, wherein the inner corner (2d) has a corner radius of more than >=0.2 mm.

11. The cylindrical secondary cell (1) according to claim 1, wherein the surface of the inner corner (2d) that is covered by the isolating part (7) lacks edges sharper than 120 degrees or lacks edges sharper than 135 degrees.

12. The cylindrical secondary cell (1) according to claim 1, wherein the isolating part (7) extends out from the terminal through-hole (2b) over at least a part of an outer surface (2g) of the can end wall (2a), and wherein an outer corner (2e) that formed where the inner peripheral surface (2c) meets and an outer surface (2g) of the can end wall (2a), is blunted and has a surface free from edges having edge angles of less than 100 degrees.

13. A method for attaching a terminal part (4) to a can end wall (2a) of a cylindrical can (2) in a process of assembling a cylindrical secondary cell (1), the method comprising:
forming (S1) a terminal through-hole in a can end wall (2a), wherein the terminal through-hole is formed such that an inner corner (2d), that is formed where an inner peripheral surface (2c) of the terminal through-hole (2b) meets an inner surface (2f) of the can end wall (2a), is blunted and has a surface free from edges having edge angles of less than 100 degrees,
inserting (S2) a terminal part (4) comprising a pin shaped body into the formed terminal through-hole (2b) to provide a connection to an electrode (3) arranged inside the cylindrical can (2), and
arranging (S3) an isolating part (7) on the inner peripheral surface of the terminal through-hole (2b) to electrically isolate the can end wall (2a) from the terminal part (4), wherein the isolating part (7) is arranged such that it covers the inner peripheral surface (2c) of the terminal through-hole (2b) and extends out from the terminal through-hole (2b) and over at least a part of the inner surface (2f) of the can end wall (2a).

14. The method of claim 13, further comprising:
applying a rivet pressure force on the terminal part (4) from inside and outside the cylindrical can (2) to rivet the terminal part (4) to the can end wall (2a).

15. The method of claim 14, wherein arranging (S3) the isolating part comprises inserting an isolating gasket in the terminal through-hole (2b).

16. The method of claim 15, wherein the arranging (S3) comprises arranging an isolating part (7) formed such that a portion of the isolating part (7) that surrounds a shaft portion (4d) of the terminal part (4) that is inserted in the terminal through hole, is thicker at its middle, and/or at its inner end, than at its outer end, with regards to the cell (1).

17. The method of claim 13, wherein the arranging (S3) the isolating part (7) comprises insert injection molding the isolating part (7) by filling a remainder of the terminal through-hole (2b) not occupied by the terminal part (4) by an isolating material, wherein the molding fixates the terminal part (4) in the terminal through-hole (2b).

18. The method of claim 13, wherein the method further comprises assembling a cylindrical secondary cell (1) comprising:
a cylindrical can (2) having a can end wall (2a),
a terminal part (4) comprising a pin shaped body inserted into a terminal through-hole (2b) formed in the can end wall (2a) and protruding out from the terminal through-hole (2b) into the cylindrical can (2) to provide a connection to an electrode (3) arranged inside the cylindrical can (2), and
an isolating part (7) arranged in the terminal through-hole (2b) to electrically isolate the can end wall (2a) from the terminal part (4),
wherein:
the isolating part (7) covers an inner peripheral surface (2c) of the terminal through-hole (2b) and extends out from the terminal through-hole (2b) and over at least part of an inner surface (2f) of the can end wall (2a), and
an inner corner (2d) of the can end wall (2a), that is formed where the inner peripheral surface (2c) of the terminal through-hole (2b) meets an inner surface (2f) of the can end wall (2a), is blunted and has a surface free from edges having edge angles of less than 100 degrees.
